(19) United States
(12) Patent Application Publication
(10) Pub. No.: US 2025/0218025 A1
(43) Pub. Date: Jul. 3, 2025

(54) OBJECT DETECTION AND LOCALIZATION FROM THREE-DIMENSIONAL (3D) POINT CLOUDS USING FIXED SCALE (FS) IMAGES

(71) Applicant: Seegrid Corporation, Pittsburgh, PA (US)

(72) Inventors: Austin Jensen, Morgan, UT (US); Thomas Panzarella, Haddonfield, NJ (US); John Spletzer, Osprey, FL (US)

(21) Appl. No.: 19/000,867

(22) Filed: Dec. 24, 2024

Related U.S. Application Data
(60) Provisional application No. 63/615,833, filed on Dec. 29, 2023.

(51) Int. Cl. G06T 7/70; G06V 10/764

(52) U.S. Cl. CPC G06T 7/70; G06V 10/764; G06T 2207/10028; G06V 2201/07

(57) ABSTRACT

In accordance with one aspect of the inventive concepts, provided is an autonomous mobile robot (AMR), comprising: at least one processor in communication with at least one computer memory device; at least one 3D sensor configured to collect 3D sensor data of an object; and a fixed scale image processing module configured to receive the 3D point cloud data; transform the 3D point cloud data into at least one fixed scale (FS) image; detect, identify, and localize the object in image space of the at least one FS image; select a plugin associated with an object type of the object; and apply the plugin for 6D (degrees of freedom) pose estimation of the object in real-world space to localize the object. In various embodiments, the object can be any type of forkable object, but in other embodiments the object need not be a forkable object.

### CROSS REFERENCE TO RELATED APPLICATIONS

The present application claims priority to U.S. Provisional Patent Application 63/615,833, filed Dec. 29, 2023, entitled, Object Detection and Localization from Three-Dimensional (3D) Point Clouds Using Fixed Scale (FS) Images, which is incorporated herein by reference.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle-Mounted Sensor; International Application No. PCT/US23/016589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement/Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure; International Application No. PCT/US23/024114, filed on Jun. 1, 2023, entitled System and Method for Generating Complex Runtime Path Networks from Incomplete Demonstration of Trained Activities; International Application No. PCT/US23/023699, filed on May 26, 2023, entitled System and Method for Performing Interactions with Physical Objects Based on Fusion of Multiple Sensors; International Application No. PCT/US23/024411, filed on Jun. 5, 2023, entitled Lane Grid Setup for Autonomous Mobile Robots (AMRs); International Application No. PCT/US23/033818, filed on Sep. 27, 2023, entitled Shared Resource Management System and Method; International Application No. PCT/US23/079141, filed on Nov. 8, 2023, entitled System And Method For Definition Of A Zone Of Dynamic Behavior With A Continuum Of Possible Actins and Locations Within Same; International Application No. PCT/US23/078890, filed on Nov. 7, 2023, entitled Method And System For Calibrating A Light-Curtain; International Application No. PCT/US23/036650, filed on Nov. 2, 2023, entitled System and Method for Optimized Traffic Flow Through Intersections with Conditional Convoying Based on Path Network Analysis; International Application No. PCT/US23/082060, filed on Dec. 1, 2023, entitled Configuring a System that Handles Uncertainty with Human and Logic Collaboration in a Material Flow Automation Solution; U.S. patent application Ser. No. 18/526,538, filed on Dec. 1, 2023, entitled Configuring a System that Handles Uncertainty with Human and Logic Collaboration in a Material Flow Automation Solution; International Application No.: PCT/US23/082248, filed on Dec. 4, 2023, entitled Systems and Methods for Material Flow Automation; U.S. patent application Ser. No. 18/527,669, filed on Dec. 4, 2023, entitled Systems and Methods for Material Flow Automation; International Application No. PCT/US23/082251, filed on Dec. 4, 2023, entitled Process Centric User Configurable Step Framework for Composing Material Flow Automation; U.S. patent application Ser. No. 18/527,699, filed on Dec. 4, 2023, entitled Process Centric User Configurable Step Framework for Composing Material Flow Automation; International Application No. PCT/US23/082255, filed on Dec. 4, 2023, entitled Generation of “Plain Language” Descriptions Summary of Automation Logic; U.S. patent application Ser. No. 18/527,715, filed on Dec. 4, 2023, entitled Generation of “Plain Language” Descriptions Summary of Automation Logic; International Application No. PCT/US23/082256, filed on Dec. 4, 2023, entitled Hybrid Autonomous System and Human Integration System and Method; U.S. patent application Ser. No. 18/524,217, filed on Nov. 30, 2023, entitled Hybrid Autonomous System and Human Integration System and Method; International Application No.: PCT/US23/082258, filed on Dec. 4, 2023, entitled System for Process Flow Templating and Duplication of Tasks within Material Flow Automation; U.S. patent application Ser. No. 18/527,730, filed on Dec. 4, 2023, entitled System for Process Flow Templating and Duplication of Tasks within Material Flow Automation; International Application No. PCT/US23/082434, filed on Dec. 5, 2023, entitled Just In Time Destination and Route Planning; U.S. patent application Ser. No. 18/529,109, filed on Dec. 5, 2023, entitled Just In Time Destination and Route Planning; International Application No: PCT/US23/082453, filed on Dec. 5, 2023, entitled Method for Abstracting Integrations Between Industrial Controls and Mobile Robots; U.S. patent application Ser. No. 18/529,229, filed on Dec. 5, 2023 entitled Method for Abstracting Integrations Between Industrial Controls and Mobile Robots; International Application No. PCT/US23/082457, filed on Dec. 5, 2023, entitled Visualization of Physical Space Robot Queuing Areas as Non-work Locations for Robotic Operations, and U.S. patent application Ser. No. 18/529,236, filed on Dec. 5, 2023, entitled Visualization of Physical Space Robot Queuing Areas as Non-work Locations for Robotic Operations, each of which is incorporated herein by reference in its entirety.

The present application may be related to U.S. patent application Ser. No. 11/350,195, filed on Feb. 8, 2006, U.S. Pat. No. 7,466,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design patent application 29/398,127, filed on Jul. 26, 2011, U.S. Patent No. D680,142, Issued on Apr. 16, 2013, entitled Multi-Camera Head; U.S. Design patent application 29/471,328, filed on Oct. 30, 2013, U.S. Pat. No. D730,847, Issued on Jun. 2, 2015, entitled Vehicle Interface Module; U.S. patent Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 17/712,660, filed on Apr. 4, 2022, US Publication Number 2022/0297734, Published on Sep. 22, 2022, entitled Laterally Operating Payload Handling Device; U.S. patent application Ser. No. 16/892,549, filed on Jun. 4, 2020, U.S. Pat. No. 11,693,403, Issued on Jul. 4, 2023, entitled Dynamic Allocation And Coordination of Auto-Navigating Vehicles and Selectors; U.S. patent application Ser. No. 18/199,052, filed on May 18, 2023, Publication Number 2023/0376030, Published on Nov. 23, 2023, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022/0100195, Published on Mar. 31, 2022, entitled Vehicle Object-Engagement Scanning System And Method; U.S. patent application Ser. No. 17/478,338, filed on Sep. 17, 2021, US Publication Number 2022/0088980, Published on Mar. 24, 2022, entitled Mechanically-Adaptable Hitch Guide; U.S. patent application Ser. No. 29/832,212, filed on Mar. 25, 2022, entitled Mobile Robot, each of which is incorporated herein by reference in its entirety.

### FIELD OF INTEREST

The present inventive concepts relate to the field of autonomous mobile robots (AMRs) and/or robotic vehicles. More specifically, the present inventive concepts relate to systems and methods of object detection and localization.

### BACKGROUND

Some autonomous mobile robots (AMRs) operate autonomously in unstructured manufacturing and warehouse environments. Some of these AMRs include a plurality of sensors that collect three-dimensional (3D) sensor data that represents the environment and objects in the environment.

In these applications, the ability to 1) detect/classify objects in the scene, and 2) localize the relative pose (i.e., position and orientation) of those objects with respect to the vehicle is of critical importance. For example, to interface with infrastructure in the environment (e.g., pallets), the AMR needs to first identify the object it needs to pick (e.g., a CHEP pallet), and then localize its relative pose so it can plan a proper trajectory and provide feedback to its manipulator actuators to spear the pallet properly. Object detection and localization can also enhance AMR scene understanding and situation awareness. For example, recognizing that there are people in the immediate vicinity would allow an AMR to dynamically adjust (e.g. reduce) its speed to enhance personnel safety. Some current lift trucks employ an off-the-shelf 3D sensor to detect and localize pallets. However, detection capabilities of this off-the-shelf 3D sensor are limited to pallet-like objects and cannot generalize to other object classes. FIG. 1 provides embodiments of various types of pallets known in the art.

Deep learning solutions are the “state of the art” for object detection. Arguably, the most mature of these approaches employ convolutional neural networks (CNNs). CNNs operate on images, and are able to classify and localize objects in an image with a high degree of accuracy. As such, they are well suited for real-time detection with cameras. However, cameras are just one sensor employed by AMRs. 3D Light Detection and Ranging (LiDAR) sensors have become the de facto standard in the industry for applications such as AMR localization and obstruction detection. Instead of images, these sensors generate 3D point clouds where each point is a discrete 3D sample of the position of an object in the scene. This different data representation and structure dictates different approaches to object detection. There has also been significant research in this area employing deep learning solutions. However, the approaches are arguably less mature, less efficient, and less standardized.

It is an object of the inventive concepts to provide a method and a system that detect, classify, and localize such objects from three-dimensional (3D) point clouds.

### SUMMARY OF THE INVENTION

In accordance with aspects of the inventive concepts, provided is an autonomous mobile robot (AMR), comprising at least one processor in communication with at least one computer memory device; at least one 3D sensor configured to collect 3D sensor data of an object; and a fixed scale image processing module configured to receive the 3D point cloud data; transform the 3D point cloud data into at least one fixed scale (FS) image; detect, identify, and localize the object in image space of the at least one FS image; select a plugin associated with an object type of the object; and apply the plugin for 6D (degrees of freedom) pose estimation of the object in real-world space to localize the object.

In various embodiments, the at least one FS image comprises pixels that correspond to real-world 3D positions and physical dimensions.

In various embodiments, the fixed scale image processor is configured to directly estimate the real-world object size from the at least one FS image.

In various embodiments, a scale in the FS image is fixed such that a pixel in the FS image represents a fixed area measurement in the real-world.

In various embodiments, the AMR further comprises a load engagement apparatus configured to engage the object.

In various embodiments, the load engagement apparatus comprises at least one fork.

In various embodiments, the fixed scale image processing module is configured to identify and localize an object from the at least one FS image.

In various embodiments, the object is a forkable object, wherein the term “forkable” refers to an ability to engage and pick a pallet or any other object configured to receive the forks of the AMR.

In various embodiments, the forkable object is a pallet.

In various embodiments, the forkable object is an industrial rack, cart, or container.

In various embodiments, the fixed scale image processing module is further configured to generate a signal indicating the object was localized or localization failed based on the 6D pose estimation of the object.

In various embodiments, the fixed scale image processing module configured to use the localization plugins to exploit prior class information to detect errors, optionally, wherein such errors include an object's bounding box being poorly located or the object being misclassified.

In accordance with another aspect of the inventive concepts, provided is an object detection and localization method performable by an autonomous mobile robot (AMR), comprising: providing an AMR including at least one processor in communication with at least one computer memory device and at least one 3D sensor configured to collect 3D point cloud data of an object; and a fixed scale (FS) image processor. The FS processor performs steps including: receiving the 3D point cloud data; transforming the 3D point cloud data into at least one fixed scale (FS) image; detecting, identifying, and localizing the object in image space of the at least one FS image; selecting a plugin associated with an object type of the object; and localizing the object real-world space by applying the plugin for 6D (degrees of freedom) pose estimation of the object in real-world space.

In various embodiments, the at least one FS image comprises pixels that correspond to real-world 3D positions and physical dimensions of the object.

In various embodiments, the method includes directly estimating the real-world object size from the at least one FS image.

In various embodiments, a scale in the FS image is fixed such that a pixel in the FS image represents a fixed area measurement in the real-world.

In various embodiments, the AMR further comprises a load engagement apparatus configured to engage the object.

In various embodiments wherein the load engagement apparatus comprises at least one fork.

In various embodiments, the further includes identifying and localizing the object in real time or near real time.

In various embodiments, the object is a forkable object.

In various embodiments, the forkable object is a pallet.

In various embodiments, the forkable object is an industrial rack, cart, or container.

In various embodiments, the method further includes generating a signal indicating the object was localized or localization failed based on the 6D pose estimation of the object.

In various embodiments, the method further includes the localization plugins exploiting prior class information to detect errors, optionally, wherein such errors include an object's bounding box being poorly located or the object being misclassified.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1 provides embodiments of various types of pallets known in the art.

FIGS. 2A-2D provide different views of a robotic vehicle in the form of an AMR forklift that can be configured in accordance with aspects of the inventive concepts.

FIG. 3 is a block diagram of components of an embodiment of AMR of FIG. 2, in accordance with principles of inventive concepts.

FIG. 4 is an object detection and localization workflow, in accordance with aspects of the inventive concepts.

FIG. 5 is an embodiment of a method of detection and localization, in accordance with aspects of the inventive concepts.

### DESCRIPTION OF PREFERRED EMBODIMENT

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

While the inventive concepts are described herein in the context of warehouse vehicles and pallets or other fork-engageable objects, those skilled in the art will appreciate that the inventive concepts could be applied in other contexts with other objects of interest (OOI) that are to be engaged by a robot that acts on the OOI in response sensor data, particularly 3D sensor data, and more particularly 3D point cloud data. Even within the warehouse context, other objects in the environment can be the subject of the applied inventive concepts, such as racks, industrial racks, carts, or containers, and the like.

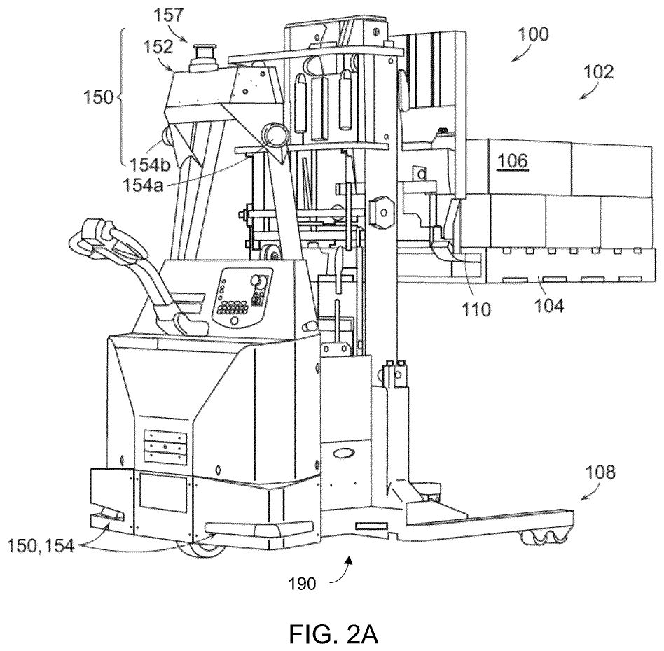

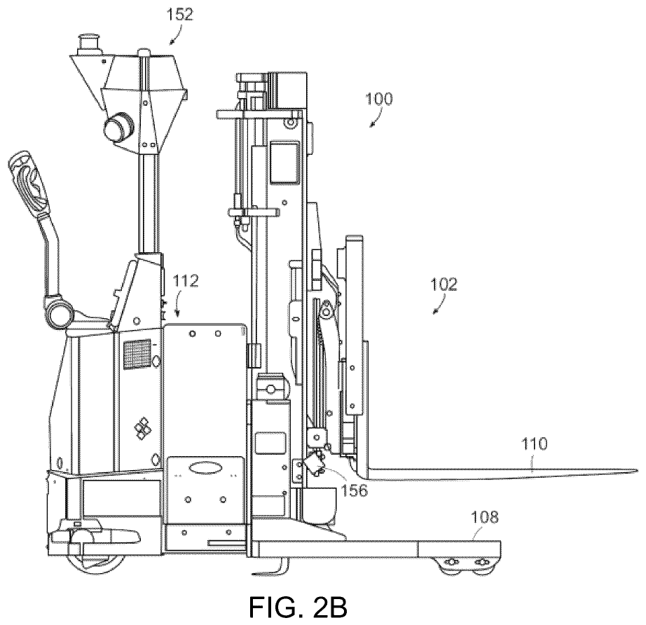

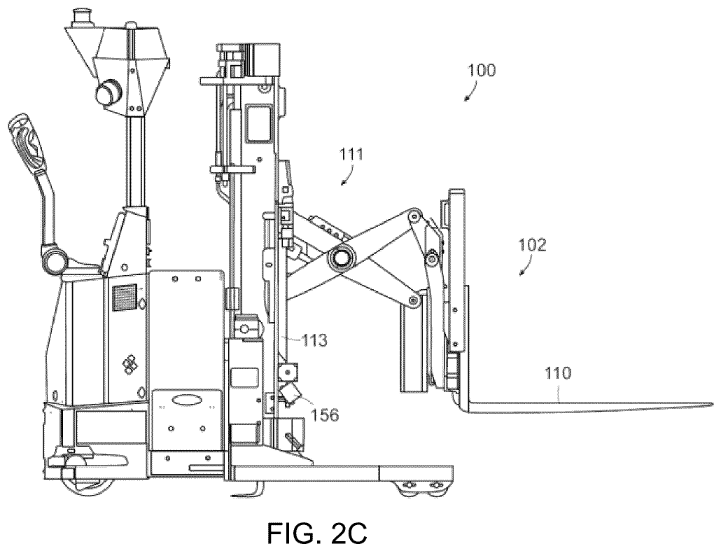

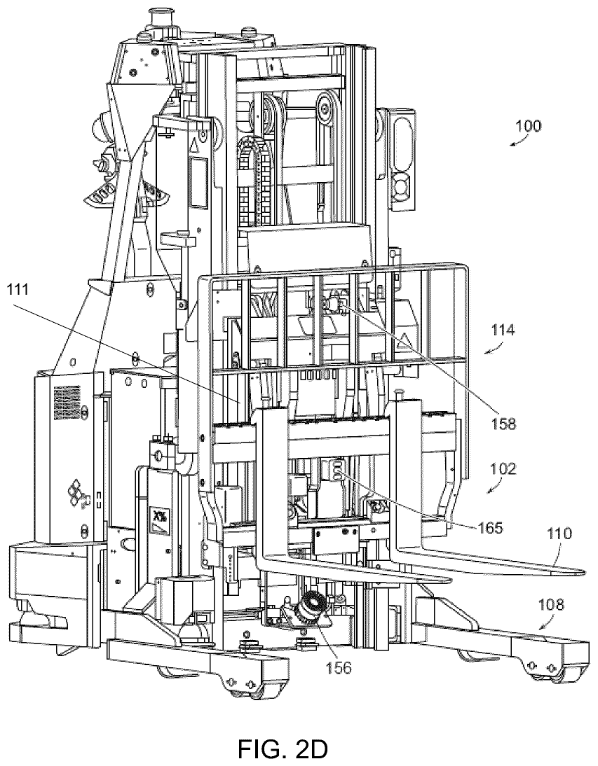

FIGS. 2A-2D, collectively, FIG. 2, provide different views of a robotic vehicle in the form of an AMR forklift 100 that can be configured in accordance with aspects of the inventive concepts.

Referring to FIG. 2, AMR 100 is configured with the sensing, processing, and memory devices and subsystems necessary and/or useful for autonomous navigation, load engagement, and load transport. The robotic vehicle 100 takes the form of an AMR pallet lift, but the inventive concepts could be embodied in any of a variety of other types of robotic vehicles and AMRs, including, but not limited to, pallet trucks, tuggers, and the like. The AMR embodiment will be described as context for the inventive concepts.

In this embodiment, AMR 100 includes a payload area 102 configured to transport a pallet 104 loaded with goods, which collectively form a palletized payload 106. To engage and carry the pallet 104, the robotic vehicle may include a load engagement apparatus configured to manipulate a load, including, for example, a pair of forks 110, including first and second forks 110a,b. In an alternative embodiment, the load engagement apparatus may include a single fork, boom, clamp, or the like. Outriggers 108 extend from a chassis 190 of the robotic vehicle in the direction of the forks to stabilize the vehicle, particularly when carrying the palletized load. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The forks 110 may be supported by one or more robotically controlled actuators 111 coupled to a carriage 114 that enable the robotic vehicle 100 to raise and lower and extend and retract to pick up and drop off loads, e.g., palletized loads 106. In various embodiments, the robotic vehicle may be configured to robotically control the yaw, pitch, and/or roll of the forks 110 to pick a palletized load in view of the pose of the load and/or horizontal surface that supports the load. In various embodiments, the robotic vehicle may be configured to robotically control the yaw, pitch, and/or roll of the forks 110 to drop a palletized load in view of the pose of the horizontal surface that is to receive the load, or drop surface.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path navigation and obstruction detection and avoidance, including avoidance of detected objects, hazards, humans, other robotic vehicles, and/or congestion during navigation.

One or more of the sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

A common task in computer vision and robotics is to identify specific objects in the scene and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The pose of an object can be estimated from sensor data.

The sensors 150 can include one or more stereo cameras 152 and/or other volumetric sensors, sonar sensors, radars, and/or Light Detection and Ranging (LiDAR) scanners or sensors 154 and 154a,b, as examples. The inventive concepts utilize particular sensors. Specifically, such sensors are associated with 3D point clouds; thus, the sensors provide a 3D point cloud as an output from either a single or multiple measurements. Examples include stereo cameras, 3D cameras, 3D LiDAR, actuated 2D LiDAR, and the like.

In various embodiments, sensor data from one or more of the sensors 150, e.g., one or more stereo cameras 152 and/or LiDAR scanners 154a,b, can be used to generate and/or update a 3-dimensional model of the environment. In the embodiment shown in FIG. 2, at least one of the LiDAR devices 154a,b can be a 2D or 3D LiDAR device. In alternative embodiments, a different number of 2D or 3D LiDAR devices are positioned near the top of the robotic vehicle 100.

In some embodiments, the sensors 150 can include sensors configured to detect objects in the payload area and/or behind the forks 110a,b. The sensors can be used in combination with others of the sensors, e.g., stereo camera head 152. In some embodiments, the sensors 150 can include one or more carriage sensors 156 oriented to collected 3D sensor data of the payload area 102 and/or forks 110. Carriage sensors 156 can include a 3D camera and/or a LiDAR scanner, as examples. In some embodiments, the carriage sensors 156 can be coupled to the robotic vehicle 100 so that they move in response to movement of the actuators 111 and/or forks 110. For example, in some embodiments, the carriage sensor 156 can be slidingly coupled to the carriage 114 so that the carriage sensors move in response to up and down movement of the forks. In some embodiments, the carriage sensors collect 3D sensor data as they move with the forks.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

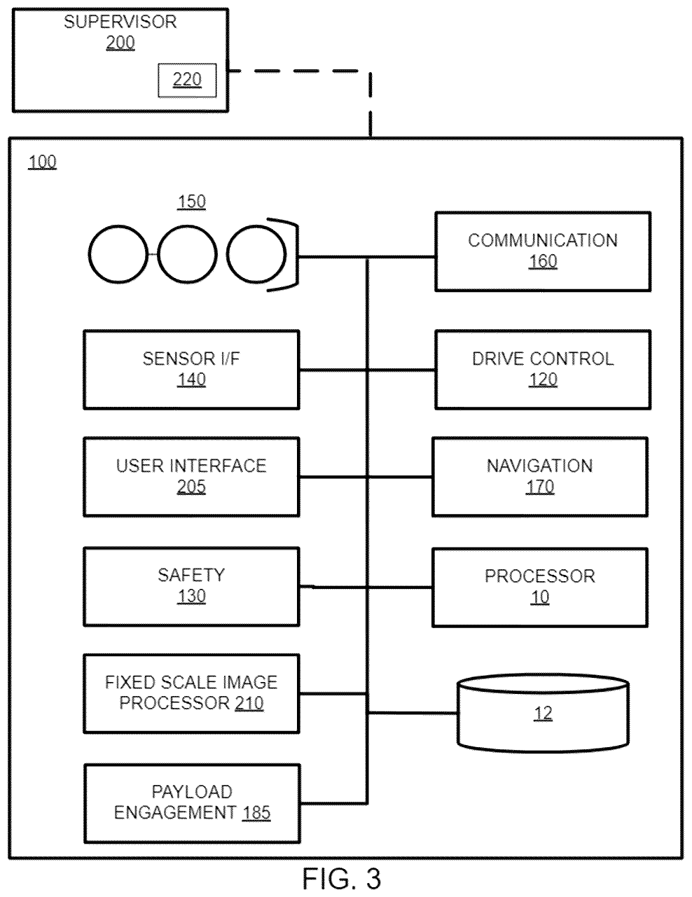

FIG. 3 is a block diagram of components of an embodiment of AMR 100 of FIG. 2, in accordance with principles of inventive concepts. The embodiment of FIG. 3 is an example; other embodiments of AMR 100 can include other components and/or terminology. In the example embodiment shown in FIGS. 2 and 3, AMR 100 is a warehouse robotic vehicle, which can interface and exchange information with one or more external systems, including a supervisor system, fleet management system, and/or warehouse management system (collectively “Supervisor 200”). In various embodiments, supervisor 200 could be configured to perform, for example, fleet management and monitoring for a plurality of vehicles (e.g., AMRs) and, optionally, other assets within the environment. Supervisor 200 can be local or remote to the environment, or some combination thereof.

In various embodiments, supervisor 200 can be configured to provide instructions and data to AMR 100, and to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers and transmitters that enable communication with supervisor 200 and any other external systems over any now known or hereafter developed communication technology, such as various types of wireless technology including, but not limited to, WiFi, Bluetooth, cellular, global positioning system (GPS), radio frequency (RF), and so on.

As an example, supervisor 200 could wirelessly communicate a path for AMR 100 to navigate for the vehicle to perform a task or series of tasks. The path can be relative to a map of the environment stored in memory and, optionally, updated from time-to-time, e.g., in real-time, from vehicle sensor data collected in real-time as robotic vehicle 100 navigates and/or performs its tasks. The sensor data can include sensor data from sensors 150. As an example, in a warehouse setting the path could include a plurality of stops along a route for the picking and loading and/or the unloading of goods. The path can include a plurality of path segments. The navigation from one stop to another can comprise one or more path segments. Supervisor 200 can also monitor AMR 100, such as to determine robotic vehicle's location within an environment, battery status and/or fuel level, and/or other operating, vehicle, performance, and/or load parameters.

As is shown in FIG. 3, in example embodiments, AMR 100 includes various functional elements, e.g., components and/or modules, which can be housed within housing 115. Such functional elements can include at least one processor 10 coupled to at least one memory 12 to cooperatively operate the vehicle and execute its functions or tasks. Memory 12 can include computer program instructions, e.g., in the form of a computer program product, executable by processor 10. Memory 12 can also store various types of data and information. Such data and information can include route data, path data, path segment data, pick data, location data, environmental data, and/or sensor data, as examples, as well as the electronic map of the environment. The sensor data can include point cloud data from 3D sensors.

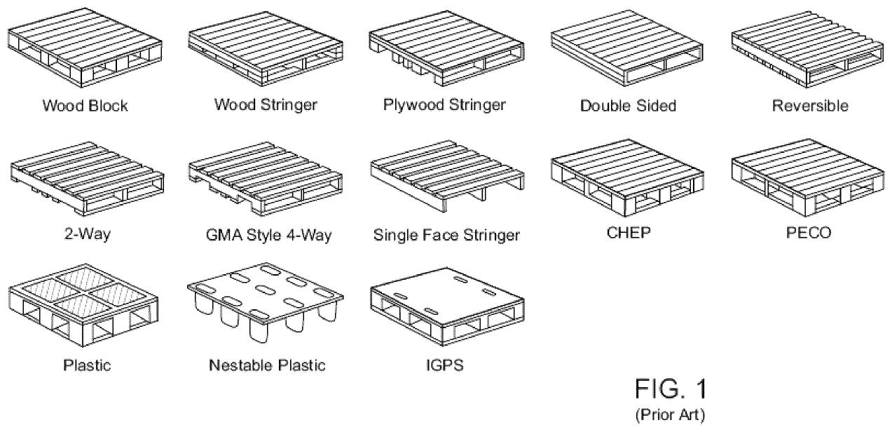

In this embodiment, processor 10 and memory 12 are shown onboard robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across supervisor 200, other vehicles, and/or other systems external to AMR 100.

The functional elements of robotic vehicle 100 can further include a navigation module 170 configured to access environmental data, such as the electronic map, and path information stored in memory 12, as examples. Navigation module 170 can communicate instructions to a drive control subsystem 120 to cause robotic vehicle 100 to navigate its path within the environment. During vehicle travel, navigation module 170 may receive information from one or more sensors 150, via a sensor interface (I/F) 140, to control and adjust the navigation of the robotic vehicle. For example, sensors 150 may provide sensor data to navigation module 170 and/or drive control subsystem 120 in response to sensed objects and/or conditions in the environment to control and/or alter the robotic vehicle's navigation. As examples, sensors 150 can be configured to collect sensor data related to objects, obstructions, equipment, goods to be picked, hazards, completion of a task, and/or presence of humans and/or other robotic vehicles.

The robotic vehicle may also include a human user interface module 205 configured to receive human operator inputs, e.g., a pick or drop complete input at a stop on the path. Other human inputs could also be accommodated, such as inputting map, path, and/or configuration information.

A safety module 130 can also make use of sensor data from one or more of sensors 150, including LiDAR scanners 154, to interrupt and/or take over control of drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause drive control subsystem 120 to stop the vehicle to avoid the hazard.

In various embodiments, AMR 100 can include a payload engagement module 185. Payload engagement module 185 can process sensor data from one or more of sensors 150, such as carriage sensors 156, and generate signals to control one or more actuators that control the engagement portion of robotic vehicle 100. For example, payload engagement module 185 can be configured to robotically control actuators 111 and carriage 114 to pick and drop payloads. In some embodiments, the payload engagement module 185 can be configured to control and/or adjust the pitch, yaw, and roll of the load engagement portion of forks 110 of robotic vehicle 100.

In some embodiments, carriage sensor 156 can be mounted to a payload engagement structure of lift mast 118 to which carriage 114, or other AMR component, is movably attached that allows the sensor 156 to move vertically with the forks 110, i.e., pair of forks (or tines), that engage and disengage from a palletized load, or payload. In some embodiments, carriage sensor 156 can be another example of a sensor 150, e.g., carriage sensor 156 of FIG. 2. In some embodiments, carriage sensor 156 is a 2D LiDAR sensor that provides PLd field occlusion detection. In preferred embodiments, carriage sensor 156 is mounted to vehicle 100 so that it is positioned to determine the presence or absence of a payload relative to the forks 110. The payload engagement structure can include mast 118 to which carriage 114 and forks 110 are movably attached, so that carriage 114 and forks 110 can move up and down vertically to engage (pick), carry, and disengage from (drop off) payload 106. In various embodiments, sensor 156 is not mounted between forks 110, but at other locations on vehicle 100 to sense a presence of objects between forks 110. In preferred embodiments, carriage sensor 156 is mounted such that during use there is a direct visible path between carriage sensor 156 and forks 110 in the absence of a pallet 104 or payload 106.

In various embodiments, carriage sensor 156 could include a single laser scanner alone or in combination with other sensors. In various embodiments, carriage sensor 156 could include a plurality of laser scanners, whether 2D or 3D. In various embodiments, the payload scanner can include one or more sensors and/or scanners configured to sense the presence or absence of an object and/or an edge of an object. The sensor or sensors used for the inventive object detection and localization is not restricted to laser scanners (aka LiDARs). In various embodiments, it or they could be a 3D camera or a stereo camera. Regardless of the particular sensor or sensors chosen, the output must be a 3D point cloud.

In accordance with the inventive concepts, provided is a method and a system that detect, classify, and localize such objects from three-dimensional (3D) point clouds. The method can be carried out by the fixed scale (FS) image processor 210 of FIG. 3, in collaboration with other modules described in related to FIG. 3.

Deep learning solutions are the “state of the art” for object detection. Arguably, the most mature of these approaches employ convolutional neural networks (CNNs). CNNs operate on images, and are able to classify and localize objects in an image with a high degree of accuracy. As such, they are well suited for real-time detection with cameras. However, cameras are just one sensor employed by AMRs. 3D Light Detection And Ranging (LiDAR) sensors have become the de facto standard in the industry for applications such as AMR localization and obstruction detection. Instead of images, these sensors generate 3D point clouds where each point is a discrete 3D sample of the position of an object in the scene. This different data representation and structure dictates different approaches to object detection. There has also been significant research in this area employing deep learning solutions. However, the approaches are arguably less mature, less efficient, and less standardized.

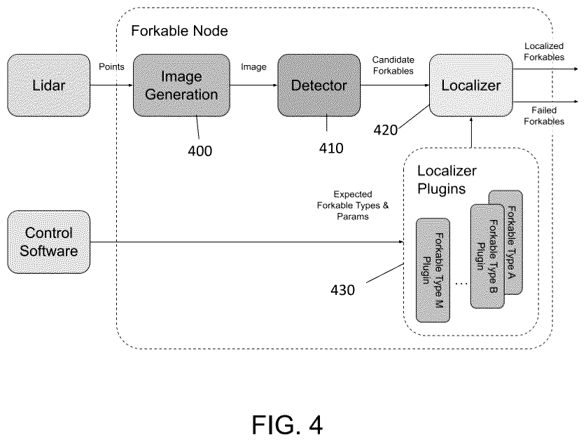

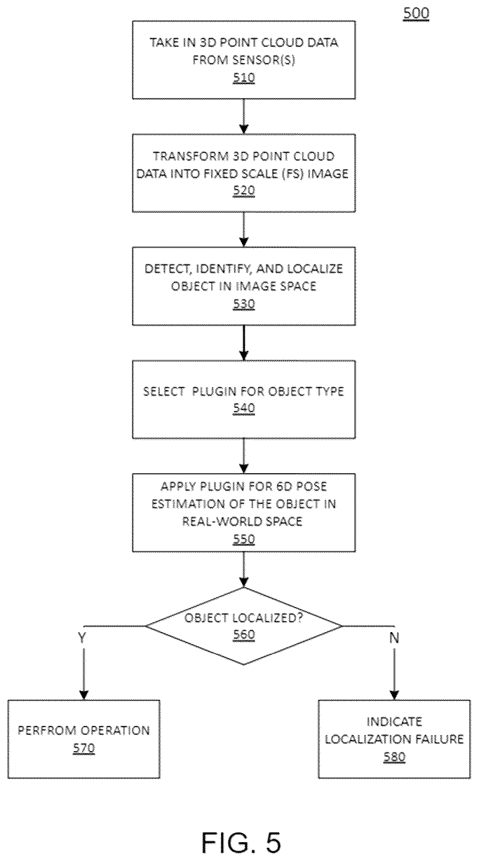

FIG. 4 is an object detection and localization workflow, in accordance with aspects of the inventive concepts. And FIG. 5 is an embodiment of a method of detection and localization 500, in accordance with aspects of the inventive concepts. The two figures will be described together for ease of explanation. Without loss of generality, this example is specific to objects that are being picked by a forklift. In FIG. 4, the term “forkable” refers to an ability to engage and pick a pallet or any other object configured to receive the forks of the AMR, such as the pallets in FIG. 1. While the current embodiment is described in connection with a fork with a pair of fork tines configured to engage and pick a pallet, the AMR may include any apparatus capable of engaging and picking an object. For example, the AMR may include a single fork tine, boom, clamp, or the like. A “forkable node” refers to a computer process connected to other processes along data boundaries. Other implementations can be imagined.

In this example, the Forkable node takes as input “Points” data from the LiDAR node. It outputs the pose of “localized forkables” objects, as well as “failed forkables” that were detected but for some reason could not be reliably localized. This implies that an object has to be detected before it can be localized.

Referring to FIGS. 4 and 5, the inventive concepts take a 3D point cloud from a LiDAR, 3D camera, stereo camera, or other point cloud data source as input, in step 510, and transforms the point cloud sensor data into a novel Fixed Scale (FS) image representation, in Image Generation module 400, in step 520. In accordance with aspects of the inventive concepts, FS images can embed both geometric and appearance information. This allows CNNs to be efficiently employed for object detection and class identification using unstructured point cloud data. In accordance with the inventive concepts, the system defines localization in the 3D world—not in an image. The CNN does localize the object in the image, but the localization accuracy can be coarse or have error. Thus, the system uses the localizer module 420 for estimating the 6D pose of the object in the world (not the image), as well as to validate the results from the CNN. It is also why the object can be detected (in the CNN) but localization can fail.

Next, the object is detected, identified, and localized in the FS image space by the detector module 410, in step 530. At this stage localization is in image space and not the 6D pose of the object relative to the vehicle that is required. 6D pose estimation refers to determining the six degree-of-freedom (6D) pose of an object in 3D space based on the point cloud data. The detector module 410 outputs candidate forkables to localizer module 420. In step 540, a plugin is selected for object type. The localizer module 420 uses the output of the detector module 410 and, under the control of Control Software (fixed scale image processor 210), selects a Forkable Type localization plugin from a localizer plugin module 430, in step 540, to be used to recover the 6D pose of the forkable object, in step 550. That is, different types of forkables can have different localization plugins that exploit the known identity and structure of the object to facilitate localization. In step 550, in the localizer module 420, the selected plugin is applied for 6D pose estimation of the object in real-world space. In step 560, if the object, e.g., a forkable object in this case, is localized a signal indicating that the object was localized (localized forkable) is output and a desired operation can be performed in step 570, such as AMR 100 picking the forkable object. But if the object is not localized in step 560, an indication of localization failure can be generated by the control software (FS image processor 210) and a signal indicating localization failed (failed forkable) is output. That is, the FS image processor 210 is configured to generate a signal indicating the object was localized (localized forkable) or localization failed (failed forkable) based on the 6D pose estimation of the object. The fixed scale image processor 210 is configured to use the localization plugins to exploit prior class information to detect errors, optionally, wherein such errors include an object's bounding box being poorly located or the object being misclassified.

One cause for localization failure will be an error in the detector module 410. Possible detector module 410 errors include the object's bounding box being poorly located, or the object being misclassified (e.g., an industrial rack is identified as a block pallet). The localization plugins exploit prior class information to be able to detect such errors. This provides a level of redundancy against localization errors. This is especially important when coupled with CNN's, which are often used as a “black box” for object detection.

Core to enabling the present inventive concepts are:
An algorithm for converting 3D point clouds into FS images.
A CNN network architecture, for example, CNN network architecture EfficientDet. (See https://arxiv.org/abs/1911.09070)
Training data for the CNN. Point cloud scans of the different object classes are required. These are subsequently transformed to FS images and serve as input for training the network and generating an application and FS-specific network model.
After training, the custom network model can then be used in real time:
   Take an input point cloud from the sensor,
   Convert it to an FS image,
   Run inference against the trained CNN model to detect and classify the object in the image, and
   Run the corresponding localization plugin for the given class to recover the object's pose (position and orientation) in the world frame.

Classes can be chosen based on context. Examples relevant to the current embodiment include various pallets (e.g., stringer, CHEP, PECO) could each be a different class. Another example can include industrial racks, where different rack configurations could be different classes. Other, less apparent, examples could include a boat. “Pleasurecraft” boats are often stored in large, indoor racks in marinas. They are picked and stowed using forklifts, and as such could be classified as a forkable object.

The CNN network architecture used in various embodiments is open source under the GNU Lesser General Public License v3.0. The training data collected can be collected through AMR training runs. Once the CNN is trained, the resulting model is stored. The localization plugins can be provided.

There are many different CNN architectures that could be used in various embodiments. In each case, CNN architecture is first chosen. Then an instance of that architecture is trained with application or context specific data, which results in a CNN model that is specific to the provided training data and which can be deployed and used in the specific application.

In some embodiments, the EfficientDet architecture is chosen as the CNN architecture. The architecture was trained with FS images of forkables, to provide a model that is specific to FS images—not normal perspective image—and the provided forkable training data. It will work well detecting objects from the provided forkable classes and when provided an FS image.

In accordance with aspects of inventive concepts, a system and method generate fixed scale (FS) images from point cloud data. It embeds the scene geometry with a fixed scale. In the FS images, image pixels correspond to real-world 3D positions and physical dimensions. This representation allows direct conversion from image pixel locations to real-world locations. The system and method are configured to directly estimate the object size. The fixed scale image processor 210 is configured to directly estimate the real-world object size from the at least one FS image. A scale in the FS image is fixed such that a pixel in the FS image represents a fixed area measurement in the real-world. For example, if the system uses a pixel width of 5 mm, an object that is 100 pixels wide in the image would be 5 mm×100=500 mm wide in the real world. Since the scale is fixed, it would be 100 pixels wide whether it was 1 meter away or 5 meters away from the sensor. This is in sharp contrast to more traditional perspective/angle images where the width might be 100 pixels at 1 meter, but only about 20 pixels wide at 5 meters.

In the prior art, there are existing approaches to image scales or scaling. In such approaches, some LiDARs output image representations of their point clouds. However, these are typically perspective projection images or custom image formats where the x-y image coordinates map to LiDAR azimuth and elevation angles.

While the FS image representation is more intuitive and computationally efficient, other benefits in accordance with the inventive concepts are simplified training and improved network performance. Since the scale is fixed, less training samples are needed and less training time is required to achieve similar levels of performance. Furthermore, since an object's appearance in images is more consistent, the associated image features can be learned more quickly and more effectively.

While a system and method in accordance with the inventive concepts enable reliable detection and localization of objects in the scene for the lift truck to pick, other applications of the inventive concepts can include, but are not limited to:
Infrastructure detection (lift tables, racks, conveyors, etc.)
People detection
AMR detection
Human vehicle (vs AMR) detection

In various embodiments, there are 3 main steps to the inventive approach: 1) image generation from the input point cloud; 2) object detection in image space and class identification; and 3) object localization in the “real-world.” This workflow is illustrated in FIG. 4 and FIG. 5. FIG. 4 is an object detection and localization workflow, in accordance with aspects of the inventive concepts. FIG. 5 is a flowchart indicating a method of the workflow.

We now discuss the specific steps.

### 1. FS Image Generation:

Without loss of generality and to facilitate explanation, assume 3-channel, 8-bit images. The first image channel embeds the geometric information of the scene. First specific parameters for the image representation are chosen. In various embodiments, these can include:
1. Image height and width (in pixels)
2. Pixel height and width (in meters)
3. Pixel resolution (in meters)

The image and pixel heights/widths together determine the height and width of the search volume of interest (VOI). For example, if an image size of 512×512 is chosen with a pixel height-width resolution of 5 mm×5 mm. The height and width of the VOI would be 512×5 mm=2,560 mm. The depth of the VOI comes from the pixel resolution. For example, the range of pixel values for 8-bit unsigned images is 0 to 255. If the pixel resolution is set to 10 mm, then the depth of our VOI is 255*10 mm=2,550 mm. In practice, the values of these parameters are tuned to the specific use case.

With these parameters in place, FS images are formed by mapping 3D world points to pixel locations through an orthographic projection. Depending on the pixel size and point cloud density, multiple 3D points may map to the same 2D pixel in the image. In this case, the points are binned and pixel value (depth) would be based upon some heuristic (e.g., the mean depth of the points, the depth of the closest point, etc.).

The second and third channels of the image can embed additional point feature information. This could include appearance information (e.g., signal intensity, surface reflectivity, etc.), other geometry information (e.g., relative angle of surface normals), or other information. Regardless of the descriptor chosen, the pixels in the latter channels will be registered to the first channel, meaning the pixel locations will be mapped to the same physical positions of objects in the real world.

### 2. Object Detection and Classification:

A CNN trained on FS images is used for detecting and classifying objects in image space. The training data for the CNN are also point clouds transformed to FS images. As mentioned previously, the structure of FS images lends itself to CNN approaches. Since the scale is fixed, less training samples are needed and less training time is required. Furthermore, object dimensions are consistent from image to image so the associated image features can be learned more quickly and more effectively.

At run time, inference is run on the trained CNN using FS images that are generated in real time from 3D point clouds (e.g., from LiDAR scans). This provides a bounding box with the object's location in image space, along with the object's class.

### 3. Localization:

The fixed scale image processing module 210 is configured to identify and localize the object in real time or near real time. Localization takes as input the bounding box of the object in image space, along with the object's class. The bounding box provides a coarse localization estimate since pixel values in the first image channel map directly to 3D world points. The class is important as it is used to determine which localization plugin is used. Localization plugins can be model based or leverage deep learning segmentation approaches. To this point, in various embodiments, the former have been employed. Using both 2D and 3D features reconstructed from the FS image, the pose (position and orientation) of the object can be estimated. Furthermore, since the plugin is class-based, the localization module can exploit prior knowledge specific to the class. For example, these are leveraged to provide robustness against CNN detection or classification errors. This redundancy is especially important as CNNs are often employed as “black boxes.” The localization plugin enables additional validation gates to be put in place to protect against CNN errors.

In various embodiments, the image geometric data are embedded in the first image channel. Standard images have 3 channels (e.g., red-green-blue). This leaves two additional channels to embed different descriptors. In one embodiment, the three channels are: 1) depth, 2) intensity of the reflected IR light, and 3) ambient IR light or noise in the scene. The second and third channels provide appearance information in addition to the geometric information of the first channel. In alternative embodiment, other fields could be used for the second and third channels.

In the event that the point cloud contains no additional data except the point positions, the approach can still be used with only geometric information.

While the inventive concepts have been described in the context of AMRs, they may alternatively or additionally be applied in other contexts, such as general robotics and automation, as examples.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provide in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can combined in any given way.

Below follows an itemized list of statements describing embodiments in accordance with the inventive concepts:

1. An autonomous mobile robot (AMR), comprising:
at least one processor in communication with at least one computer memory device;
at least one 3D sensor configured to collect 3D point cloud data of an object; and
a fixed scale image processing module configured to:
receive the 3D point cloud data;
transform the 3D point cloud data into at least one fixed scale (FS) image;
detect, identify, and localize the object in image space of the at least one FS image;
select a plugin associated with an object type of the object; and
apply the plugin for 6D (degrees of freedom) pose estimation of the object in real-world space to localize the object.

2. The AMR of statement 1, or any other statement or combination of statements, wherein the at least one FS image comprises pixels that correspond to real-world 3D positions and physical dimensions of the object.

3. The AMR of statement 1, or any other statement or combination of statements, wherein the fixed scale image processor is configured to directly estimate the real-world object size from the at least one FS image.

4. The AMR of statement 1, or any other statement or combination of statements, wherein a scale in the FS image is fixed such that a pixel in the FS image represents a fixed area measurement in the real-world.

5. The AMR of statement 1, or any other statement or combination of statements, wherein the AMR further comprises: a load engagement apparatus configured to engage the object.

6. The AMR of statement 5, or any other statement or combination of statements, wherein the load engagement apparatus comprises at least one fork.

7. The AMR of statement 1, or any other statement or combination of statements, wherein the fixed scale image processing module is configured to identify and localize the object in real time or near real time.

8. The AMR of statement 1, or any other statement or combination of statements, wherein the object is a forkable object.

9. The AMR of statement 1, or any other statement or combination of statements, wherein the forkable object is a pallet.

10. The AMR of statement 1, or any other statement or combination of statements, wherein the forkable object is an industrial rack, cart, or container.

11. The AMR of statement 1, or any other statement or combination of statements, wherein the fixed scale image processing module is further configured to generate a signal indicating the object was localized or localization failed based on the 6D pose estimation of the object.

12. The AMR of statement 1, or any other statement or combination of statements, wherein the fixed scale image processing module configured to use the localization plugins to exploit prior class information to detect errors, optionally, wherein such errors include an object's bounding box being poorly located or the object being misclassified.

13. An object detection and localization method performable by an autonomous mobile robot (AMR), comprising:
providing an AMR including at least one processor in communication with at least one computer memory device and at least one 3D sensor configured to collect 3D point cloud data of an object; and
a fixed scale image processor performing steps including:
receiving the 3D point cloud data;
transforming the 3D point cloud data into at least one fixed scale (FS) image;
detecting, identifying, and localizing the object in image space of the at least one FS image;
selecting a plugin associated with an object type of the object; and
localizing the object real-world space by applying the plugin for 6D (degrees of freedom) pose estimation of the object in real-world space.

14. The method of statement 13, or any other statement or combination of statements, wherein the at least one FS image comprises pixels that correspond to real-world 3D positions and physical dimensions of the object.

15. The method of statement 13, or any other statement or combination of statements, wherein the method includes directly estimating the real-world object size from the at least one FS image.

16. The method of statement 13, or any other statement or combination of statements, wherein a scale in the FS image is fixed such that a pixel in the FS image represents a fixed area measurement in the real-world.

17. The method of statement 13, or any other statement or combination of statements, wherein the AMR further comprises:
a load engagement apparatus configured to engage the object.

18. The AMR of statement 17, or any other statement or combination of statements, wherein the load engagement apparatus comprises at least one fork.

19. The method of statement 13, or any other statement or combination of statements, wherein the method further includes identifying and localizing the object in real time or near real time.

20. The method of statement 13, or any other statement or combination of statements, wherein the object is a forkable object.

21. The method of statement 13, or any other statement or combination of statements, wherein the forkable object is a pallet.

22. The method of statement 13, or any other statement or combination of statements, wherein the forkable object is an industrial rack, cart, or container.

23. The method of statement 13, or any other statement or combination of statements, wherein the method further includes generating a signal indicating the object was localized or localization failed based on the 6D pose estimation of the object.

24. The method of statement 13, or any other statement or combination of statements, wherein the method further includes the localization plugins exploiting prior class information to detect errors, optionally, wherein such errors include an object's bounding box being poorly located or the object being misclassified.

1. An autonomous mobile robot (AMR), comprising:
at least one processor in communication with at least one computer memory device;
at least one 3D sensor configured to collect 3D point cloud data of an object; and
a fixed scale image processing module configured to:
receive the 3D point cloud data;
transform the 3D point cloud data into at least one fixed scale (FS) image;
detect, identify, and localize the object in image space of the at least one FS image;
select a plugin associated with an object type of the object; and
apply the plugin for 6D (degrees of freedom) pose estimation of the object in real-world space to localize the object.

2. The AMR of claim 1, wherein the at least one FS image comprises pixels that correspond to real-world 3D positions and physical dimensions of the object.

3. The AMR of claim 1, wherein the fixed scale image processor is configured to directly estimate the real-world object size from the at least one FS image.

4. The AMR of claim 1, wherein a scale in the FS image is fixed such that a pixel in the FS image represents a fixed area measurement in the real-world.

5. The AMR of claim 1, wherein the AMR further comprises:
a load engagement apparatus configured to engage the object.

6. The AMR of claim 5, wherein the load engagement apparatus comprises at least one fork.

7. The AMR of claim 1, wherein the fixed scale image processing module is configured to identify and localize the object in real time or near real time.

8. The AMR of claim 1, wherein the object is a forkable object.

9. The AMR of claim 1, wherein the forkable object is a pallet.

10. The AMR of claim 1, wherein the forkable object is an industrial rack, cart, or container.

11. The AMR of claim 1, wherein the fixed scale image processing module is further configured to generate a signal indicating the object was localized or localization failed based on the 6D pose estimation of the object.

12. The AMR of claim 1, wherein the fixed scale image processing module configured to use the localization plugins to exploit prior class information to detect errors, optionally, wherein such errors include an object's bounding box being poorly located or the object being misclassified.

13. An object detection and localization method performable by an autonomous mobile robot (AMR), comprising:
providing an AMR including at least one processor in communication with at least one computer memory device and at least one 3D sensor configured to collect 3D point cloud data of an object; and
a fixed scale image processor performing steps including:
receiving the 3D point cloud data;
transforming the 3D point cloud data into at least one fixed scale (FS) image;
detecting, identifying, and localizing the object in image space of the at least one FS image;
selecting a plugin associated with an object type of the object; and
localizing the object real-world space by applying the plugin for 6D (degrees of freedom) pose estimation of the object in real-world space.

14. The method of claim 13, wherein the at least one FS image comprises pixels that correspond to real-world 3D positions and physical dimensions of the object.

15. The method of claim 13, wherein the method includes directly estimating the real-world object size from the at least one FS image.

16. The method of claim 13, wherein a scale in the FS image is fixed such that a pixel in the FS image represents a fixed area measurement in the real-world.

17. The method of claim 13, wherein the AMR further comprises:
a load engagement apparatus configured to engage the object.

18. The AMR of claim 17 wherein the load engagement apparatus comprises at least one fork.

19. The method of claim 13, wherein the method further includes identifying and localizing the object in real time or near real time.

20. The method of claim 13, wherein the object is a forkable object.

21. The method of claim 13, wherein the forkable object is a pallet.

22. The method of claim 13, wherein the forkable object is an industrial rack, cart, or container.

23. The method of claim 13, wherein the method further includes generating a signal indicating the object was localized or localization failed based on the 6D pose estimation of the object.

24. The method of claim 13, wherein the method further includes the localization plugins exploiting prior class information to detect errors, optionally, wherein such errors include an object's bounding box being poorly located or the object being misclassified.
